(19) United States
(12) Patent Application Publication
(10) Pub. No.: US 2017/0136854 A1
(43) Pub. Date: May 18, 2017

(54) Day and Night Sun Protection System and Method

(71) Applicant: Daniel Dunne, Lawton, OK (US)

(72) Inventor: Daniel Dunne, Lawton, OK (US)

(21) Appl. No.: 15/261,609

(22) Filed: Sep. 9, 2016

Related U.S. Application Data
(63) Continuation-in-part of application No. 14/939,247, filed on Nov. 12, 2015, now abandoned.

(51) Int. Cl. B60J 1/20; B60J 3/02; B60W 10/30; B60R 1/04

(52) U.S. Cl. CPC B60J 1/2011; B60R 1/04; B60J 3/02; B60W 10/30; B60W 2510/06; B60W 2530/00

(57) ABSTRACT

A sun protection system for a vehicle. The system assists maintaining interior temperature level of vehicle. The system includes a series of one or more rigid retractable, darkened, translucent plastic material panels. The panels are retractably installed inside door panels of side windows. The panels are incrementally retractable independent of side windows. The panels are manually or automatically configured to cover or expose one or more portions of side windows responsive to at least one of current detected interior temperature level, amount of sunlight entering the vehicle, or maintain an interior temperature level responsive to a predicted interior temperature level of the vehicle.

### CROSS-REFERENCE TO RELATED APPLICATION

The present application is related to and claims priority from prior provisional application Ser. No. 62/079,440, filed Nov. 13, 2014 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of retractable sun shade systems for automobiles and more specifically relates to a window shading system specially designed for automobiles that can be either manually or automatically operated to offer a unique, user-friendly alternative to standard tinting film while promoting optimal sun protection, privacy, aesthetic appeal, and even noise reduction.

2. Description of the Related Art

To combat the power of the sun while driving, motorists usually employ the car's sun visor, or simply don a pair of shades. Still others go an extra step, covering their windows with dark tinting film that filters light and heat. Although tinting is a practical accessory, many motorists view tinting as more an accoutrement that offers aesthetic appeal and privacy. Regardless of reasons for employing tinting, however, there can be drawbacks to its use. Depending on the level of tint, film-covered windows can be a bit difficult to see through on days that are cloudy, and especially at night.

As a result, the improved visibility that is achieved when the sun is at its highest is rendered practically nonexistent when driving during inclement weather or after the sun has gone down. In addition, standard tinting film can be difficult to maintain. In warmer climates, it is not uncommon for tint to begin peeling and fraying. Not only does this detract from the appearance of a vehicle, it also leads to costly replacement.

Various attempts have been made to solve problems found in retractable sun shade systems for automobiles art. Among these are found in: U.S. Pat. No. 6,523,880 to Maher C. Yako; U.S. Pat. No. 7,140,662 to Kari L. Wilkinson; and U.S. Pat. No. 2,559,471 to Jacob N. Schrock. This prior art is representative of retractable sun shade systems for automobiles.

None of the above inventions and patents, taken either singly or in combination, is seen to describe the invention as claimed. Thus, a need exists for a reliable Day & Night Sun Protect System, a window shading system specially designed for automobiles that can be either manually or automatically operated to offer a unique, user-friendly alternative to standard tinting film while promoting optimal sun protection, privacy, aesthetic appeal, and even noise reduction and to avoid the above-mentioned problems.

### BRIEF SUMMARY OF THE INVENTION

In view of the foregoing disadvantages inherent in the known retractable sun shade systems for automobiles art, the present invention provides a novel Day & Night Sun Protect System (i.e., Day and Night Sun Protection System). The general purpose of the present invention, which will be described subsequently in greater detail, is to provide a window shading system specially designed for automobiles that can be either manually or automatically operated to offer a unique, user-friendly alternative to standard tinting film while promoting optimal sun protection, privacy, aesthetic appeal, and even noise reduction. The general purpose of the present invention, which will be described subsequently in greater detail is to provide a day and night sun protection system.

A sun protection system is disclosed for vehicle. The system assists maintaining interior temperature level of vehicle. This system includes a series of one or more rigid retractable, darkened, translucent plastic material panels. The panels are retractably installed inside door panels of side windows. The panels are incrementally retractable independent of side windows. Further, the panels are manually or automatically configured to cover or expose one or more portions of the side windows responsive to one or move variables. The one or more variables include at least one of current detected interior temperature level, amount of sunlight entering the vehicle, and maintain interior temperature level responsive to predicted interior temperature level of vehicle.

A method is disclosed for vehicle. The method provides sun protection for individuals, objects, and pets inside vehicle and assists maintaining interior temperature level within specified range of vehicle. The method includes the steps of: incrementally retracting a series of one or more rigid darkened, translucent plastic material panels installed inside door panels of side windows of the vehicle; and retracting independently panels of side windows manually or automatically to cover or expose one or more portions of side windows responsive to at least one of a current detected interior temperature level, and an amount of sunlight entering vehicle, and maintain interior temperature level responsive to predicted interior temperature level of vehicle.

The present invention holds significant improvements and serves as a day and night sun protection system and method. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Day & Night Sun Protect System constructed and operative according to the teachings of the present invention.

FIG. 1 shows a perspective view illustrating Day & Night Sun Protect System according to an embodiment of the present invention.

FIG. 2 is a perspective view illustrating panel(s) installed and partially retracted on side widows of vehicle according to an embodiment of the present invention of FIG. 1.

FIG. 3 is a perspective view illustrating panel(s) installed and partially retracted on windshield of vehicle according to an embodiment of the present invention of FIG. 1.

FIG. 4 is a perspective view illustrating panel(s) installed and partially retracted on rear window according to an embodiment of the present invention of FIG. 1.

FIG. 5 is a kit illustrating Day & Night Sun Protect System according to an embodiment of the present invention of FIG. 1.

FIG. 6 is a flowchart illustrating a method of use for Day & Night Sun Protect System according to an embodiment of the present invention of FIGS. 1-4.

FIG. 7 is a perspective view illustrating a mirror attached to a retractable arm mounted to a front unit to be mounted to a dashboard or center console of a vehicle according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a Day & Night Sun Protect System and Method and more particularly to a sun protection system and method as used, for example, to adjust, e.g., higher or lower temperature, and/or maintain a temperature level inside of vehicle, lower interior vehicle noise level, improve blind spot and vehicle backup visibility for vehicle passengers, for example, retracting panels when going backward, automatic lowering tinted panels when headlights of vehicle are on to improve driver night visibility, or the like.

As discussed above and below, embodiments of the present invention relate to a retractable sun shade system for automobiles and more particularly to Day & Night Sun Protect System, a window shading system specially designed for automobiles that can be either manually or automatically operated to offer a unique, user-friendly alternative to standard tinting film while promoting optimal sun protection, privacy, aesthetic appeal, and even noise reduction.

Generally speaking, Day & Night Sun Protect System is a novel product offering consumers a practical solution to the aforementioned challenges. As the name implies, Day & Night Sun Protect System comprises a specially designed standard tinting film, effectively resolving the aforementioned problems. Simply stated, Day & Night Sun Protect System is envisioned as a sun-filtering agent for automobiles that allows owners to manually or electronically adjust the shading for both day and night use.

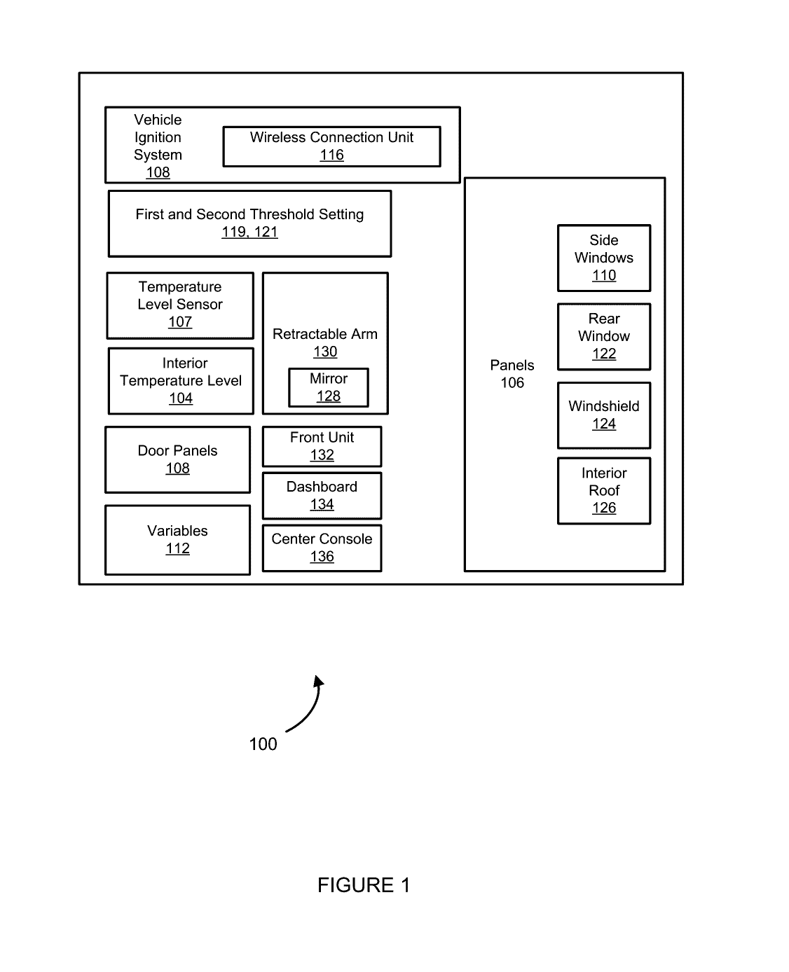

FIG. 1 shows a perspective view illustrating a Day & Night Sun Protect System according to an embodiment of the present invention.

Referring to the drawings by numerals of reference there is shown in FIG. 1, sun protection system 100 is disclosed for vehicle 102 that assists maintaining interior temperature level 104 of vehicle 102. In this system, a series of one or more rigid retractable, darkened, translucent plastic material panels 106 are utilized. Panels 106 are retractably installed inside door panels 108 of side windows 110. Panels 106 are incrementally retractable independent of side windows 110. Panels 106 are retracted manually or automatically and configured to cover or expose one or more portions 108 of side windows 110 responsive to one or more of variables 112. For example, one or more variables 112 include current detected temperature level, amount of sunlight entering vehicle 102, or maintain interior temperature level responsive to predicted interior temperature level of vehicle 102.

Furthermore, darkened panels 106 include tinting that assists filtering out harmful UV rays to assist drivers and their passengers from receiving over sun exposure. Additionally, panel(s) 106 and side window 110 being independently movable means there is natural air pocket there between. Advantageously, this natural air pocket provides a barrier and/or filters directly sunlight entering vehicle 102 that enters window 110; thus, natural air pocket facilitates energy efficiency and assists reducing vehicle fuel consumption when operating vehicle's air conditioner.

In some embodiments, darkened, translucent plastic material panels 106 include any or all the following or combinations thereof: tinted polycarbonate sheets, tinted plexiglass arylic sheets, grey tinted Lexan™ sheets, tinted polarized plastic sheets, smoked clear plastic sheets, vinyl charcoal tint, transitions photochromic sheets, plastic polymer sheets, and the like. In some embodiments, wireless connection unit 114 couples to vehicle ignition system 118. For example, wireless connection unit 116 would be a wireless router or bluetooth device capable of communicating directions and/or commands to and from ignition system 118 and operating and controlling manually, semi-automatically, or fully automatically retraction of panels 106. For example, wireless connection unit 114 automatically retracts panels 106 upon detection of vehicle ignition system 118 in off-position. In some embodiments, wireless connection unit 116 configured to automatically retract panels 106, e.g., panels 106 over, for example, side windows 110, windshield 124, rear window 122, when headlights in vehicle 102 are turned-on. In some embodiments, wireless connection unit 116 automatically configured to fully/partially retract panels 106 on rear window 122 when vehicle 102 moving in reverse direction to aid driver visibility.

In some embodiments, wireless connection unit 116, e.g., wireless router that sends communication wireless signaling between motors and pulley connected to panels 106 and wirelessly connected to ignition system 118, is configured to be responsive to a vehicle interior temperature level (e.g., measured in temperature sensor 107). For example, for vehicle interior temperature level in first threshold setting 119, wireless connection unit 116 sends electronic signal commands to raise panels 106, e.g., for example using pulley connected to window with electric motor (e.g., same hardware and electronics of that of vehicle electronic window regulator) there connected, to lower an interior temperature level of vehicle 102. In another example, for vehicle interior in temperature level (e.g., measured in temperature level sensor 107) in second threshold setting 121, wireless connection unit 116 sends electronic signal commands to lower side windows 110 to lower interior temperature level of vehicle 102. As such, system 100 predicts interior temperature level (predicted interior temperature level), e.g., when temperature level 104 hits first and/or second threshold settings 119, 121, and wireless communication unit 116 sends communication signals to retract, e.g., for example, panels 106 on side windows 110 and/or lowers side windows 110 to maintain interior temperature level, e.g., desired interior temperature level, or as close as possible to desired interior temperature level.

In summary, first and second threshold settings 119, 121 would provide temperature protection to first raise panels 106 to block incoming sunlight when it reaches the first threshold, then when the temperature level reaches the second threshold setting, lower windows, for example, ½ inch to release heat from the interior of the vehicle. In addition, settings 119, 121 would help to protect equipment left in the vehicle from the high temperatures. In addition, pets left in the vehicle it will help to prevent it from being harmed from excessive heat.

In some embodiments, one or more panels 106 are retractably installed in interior of vehicle 102 at rear window 122, and front interior windshield 124, and one or more panels 106 are independently incrementally retractable from each other. In some embodiments, one or more panels 106 are retractably installed in a portion of interior roof 126. In some embodiments, one or more panels 106 are independently incrementally retractable from each other. In some embodiments, and illustrated in FIG. 7, mirror 128 attaches to retractable arm 130 mounted to front unit 132. Front unit 132 would be a bracket or other attachment mechanism(s), e.g., glue, double sided tape, epoxy or the like, to secure mirror 128 with retractable arm 130 a surface or structure in vehicle 102. For example, front unit 132 mounted to dashboard 134 or center console 136 of vehicle 102. In one example, mirror 128 retracted up and out of way of windshield 124 when vehicle 102 not in use. In some embodiments, mirror 128 retracted manually into position by pulling down and locking mirror 128 into place. In some embodiments, mirror 128 automatically retracted into position when vehicle 102 is in use and out of position when vehicle 102 is not in use.

In summary, Day & Night Sun Protect System is presented as a series of flat rigid panels fabricated from a darkened, translucent plastic material similar to the kind used in light-protective eyewear. Panels would be installed inside the door panel for all side windows. Panels would also be installed in the interior of the vehicle at the rear window, and the front interior windshield. The panels located in the interior of the vehicle, for the front and back windshields, could be attached to the interior roof, with the mirror removed from the front windshield and attached to the front unit at the time of installation.

In one example, the mirror would have a retractable arm to move it up and out of the way when the vehicle is not in use. In yet another example, the mirror would be manually moved into position by pulling it down and locking it into place. Alternatively, this move in position would be done using the power system of the vehicle. In addition, the sun visors will also be attached to the unit to allow for their continued use. In another example, Day & Night Sun Protect System would be manually operated or configured to automatically raise and lower, via wireless connection to the ignition, when the car's engine stops and starts respectively.

In this same vein, the system would be calibrated to retract panels, e.g., side windows, rear window, windshield, once the vehicle's headlights are engaged as darkness falls. As such, this safety feature will automatically enable vehicle occupants to see through windows and windshields at night, without interference. This product would be offered as a feature of new vehicles at the point of manufacture or as an aftermarket accessory.

Advantageously, Day & Night Sun Protect System would provide motorists with a hassle-free means of completely shading the windows of their automobile. A clever system that allows users complete control over shading of all windows in a vehicle without the need to stop and pull over. As such, this system would also eliminate the need to employ costly and messy strips of film tint. In this manner, motorists can enjoy the privacy afforded by tinted windows without the frustrations associated with semi-permanent, frayed, and peeling film. Offering the aesthetic appeal that many seek in tinted windows, Day & Night Sun Protection System would also serve as a buffer from outside noises.

As a result, occupants would be better able to enjoy the quality sound of their music or a quiet conversation. Most importantly, the proposed agent would feature a component that would help to filter out harmful UV rays, keeping drivers and their passengers safe from the effects of the sun. Additionally, the space between the shade and the window would create a natural air pocket, facilitating energy efficiency when it is necessary to cool the car's interior with gas-guzzling air conditioning.

Advantageously, Day & Night Sun Protection System accommodates all vehicle types, this versatile product would be ideal for small sedans as well as massive sport utility vehicles. Affordably priced, Day & Night Sun Protect System should be well received by a significant portion of automobile owners, a sizable market potential. The Day & Night Sun Protect System is cost-effective to produce in the embodiments. The concept behind the idea of this system is to give the consumers a new innovative way to protect themselves, passengers and equipment within a vehicle of any kind.

Furthermore, this innovative system was first thought of for automotive deployment. But in a similar manner, this system can support sun protection for aircraft and water craft. As such, this system would be manual or automatic deployed device that is set into panels that attach to the inside of the vehicle. In addition, this system would be attached to the ignition for automatic deployment when the vehicle is first turned on. Further, if set to manual, this innovative system will be controlled by a turn level for older model cars or a power control panel for new cars that the occupant deploys as desired. In one example, panels would be made of the same material as sunglasses so will filter out unwanted sun rays and glare. Advantageously, panels will be like an extra window so will reduce outside sound and will help to maintain inside temperature level.

Other options will include a temperature protection that can be set to first raise the device to block incoming sunlight when it reaches the first threshold, then when the temperature level reaches the second threshold setting, it will lower the windows ½ inch to release heat from the interior of the vehicle. This will help to protect equipment left in the vehicle from the high temperatures. Also, if a pet is left in the vehicle it will help to prevent it from being harmed from excessive heat.

Another option is Day & Night Sun Protect system when in automatic mode would move tinted parts, e.g., panels 106, back to storage panels when lights, e.g., headlights of vehicle, are turned on or when light turn on automatically for vehicles that have automatic lights. Advantageously, this option would allow the driver to see better at night and in adverse weather conditions which will reduce the risk of not being able to see clearly.

Still another option will be to set the rear panel to retract the tint when the vehicle is placed into reverse, allowing for clear vision. Finally, the system when in automatic will move tint back into panels when vehicle is turned off, this will help to protect police by giving them a clear view into the interior of the vehicle when they pull them over for a violation.

Advantageously, panels will be attached to interior roof for deployment of front and back windows. In pickup trucks, panels which it will be installed below the window to raise up into position. Further, door panels will be installed inside doors with rubber fitting to allow two windows to raise and lower, one the window and inside of that the sun protect system, e.g., panels 106. In exemplary example, panels would be between ¼ and ½ inch thick. The front window panel will be designed to have a roof light, mirror and sun visors attached to it. The mirror would be on a collapsible arm that can be either pulled into position or set to move into position with the deployment of the system when the vehicle is turned on. Furthermore, the mirror would not move into storage configuration when lights, e.g., vehicle headlights, are turned on.

Finally, as you can see this device is an innovative way to protect not only people from over exposure of the sun, but also pets, equipment, pedestrians and law enforcement officers. These same panels can be made for aircraft or water craft; it was not my intention to limit this device to automobile.

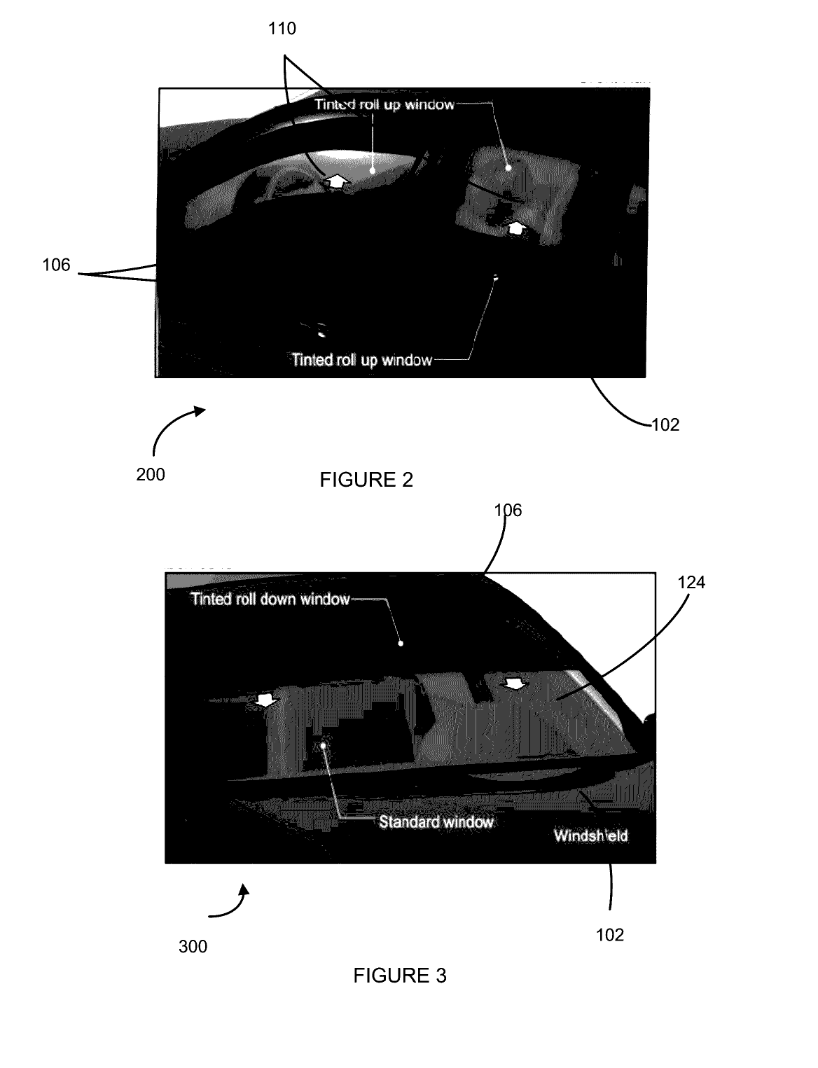

Referring now to FIG. 2, an a perspective view illustrating panel(s) installed and partially retraced on side widows of vehicle according to an embodiment of the present invention of FIG. 1.

Referring now to FIG. 3, a perspective view illustrates panel(s) installed and partially retracted on windshield of vehicle according to an embodiment of the present invention of FIG. 1.

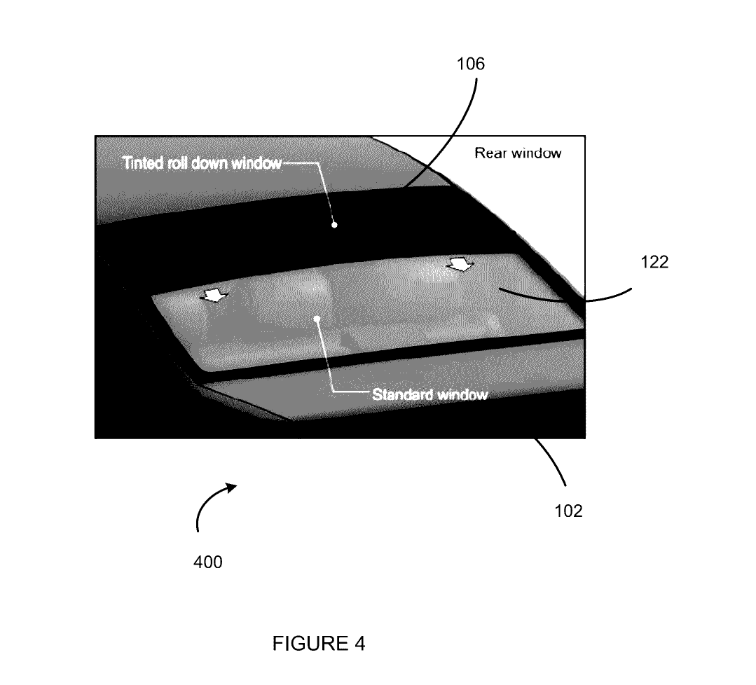

Referring now to FIG. 4, a perspective view illustrates panel(s) installed and partially retracted on rear window according to an embodiment of the present invention of FIG. 1.

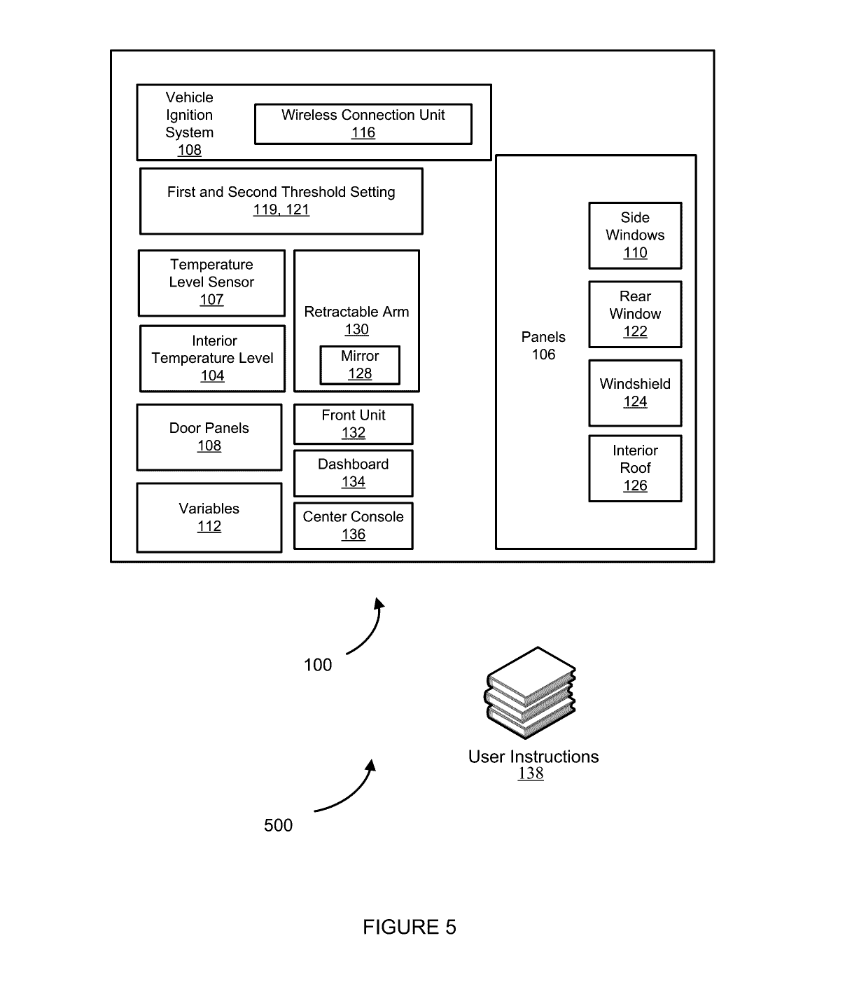

Referring now to FIG. 5, a kit illustrates Night & Day Protect System according to an embodiment of the present invention of FIG. 1.

Referring now to FIG. 5, showing Day & Night Sun Protect system 100. Sun protection system 100 may be sold as kit 500 comprising the following parts: at least one set of rigid, tinted, translucent panels 106 (e.g., for side windows 110, windshield 124, rear window 122); at least one wireless connection unit 116; at least one retractable arm 130 including one mirror 128; at least one set of door panels 108; at least one temperature level sensor 107; and at least one set of user instructions 138. The kit has instructions such that functional relationships are detailed in relation to the structure of the invention (such that the invention can be used, maintained, or the like in a preferred manner). Day & Night Sun Protect System 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

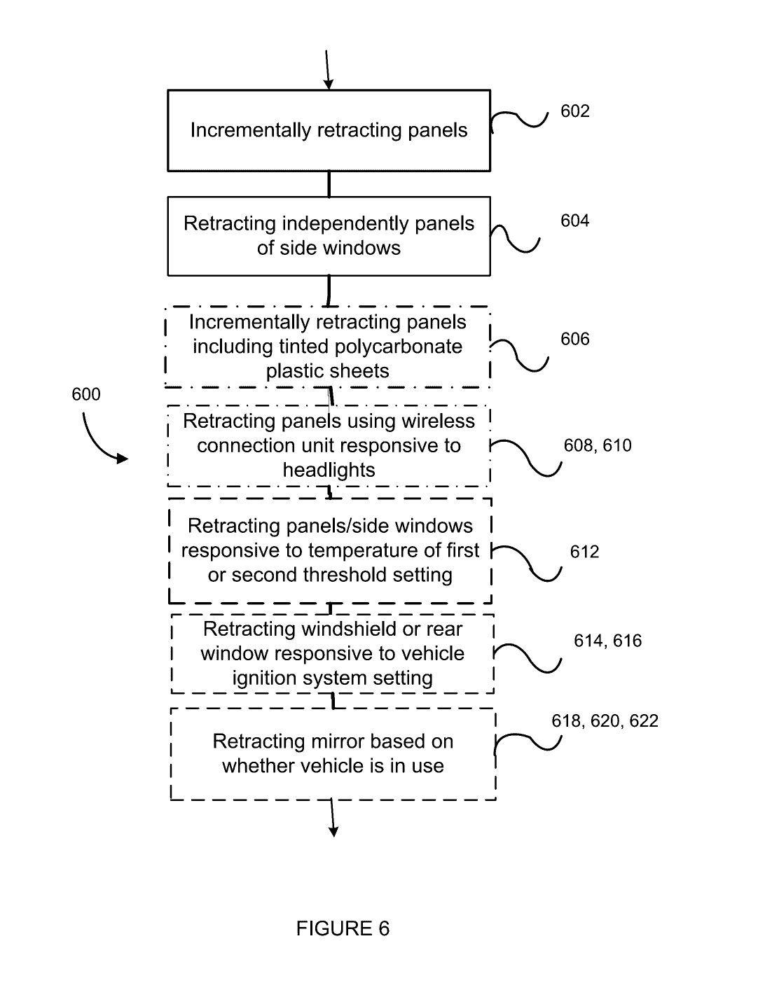

Referring now to FIG. 6, a flowchart illustrates a method of use for Day & Night Sun Protect System according to an embodiment of the present invention of FIGS. 1-4.

In FIG. 6, method 600 is disclosed for vehicle 102 to provide sun protection. The sun protection is for individuals, objects, and pets inside vehicle 102. Further, the sun protection assists maintaining interior temperature level within a specified range of vehicle 102. In step 602, incrementally retracting a series of one or more rigid darkened, translucent plastic material panels 106 installed inside door panels 108 of side windows 110 of vehicle 102. In step 604, retracting independently panels 106 of side windows 110 and manually or automatically cover or expose one or more portions of side windows 110 responsive to at least one of 1.) current detected interior temperature level, and 2.) amount of sunlight entering vehicle 102, or maintain interior temperature level responsive to predicted interior temperature level of vehicle 102.

In step 606, incrementally retracting the darkened, translucent plastic material panels 106 include incrementally retracting panels 106 including materials any or all the following or combinations thereof: tinted polycarbonate sheets, tinted plexiglass arylic sheets, grey tinted Lexan™ sheets, tinted polarized plastic sheets, smoked clear plastic sheets, vinyl charcoal tint, transitions photochromic sheets, plastic polymer sheets, and the like. In step 608, retracting automatically panels 106 upon detection of vehicle ignition system 118 in an off-position using wireless connection unit 116 coupled to vehicle ignition system 118.

In step 610, comprising retracting automatically panels 106 when headlights in the vehicle 102 are turned-on using wireless connection unit 116 to vehicle ignition system 118. In step 612, responsive to interior temperature level in a first threshold setting 119, raising panels 106 to lower interior temperature level of vehicle 102, and responsive to an interior temperature level in a second threshold setting 121, lowering side windows 110 to lower temperature level of vehicle 102 utilizing wireless connection unit 116 coupled to vehicle ignition system 118. In step 614, independently retracting one or more panels 106 in interior of vehicle 102 at rear window 122, and windshield 124 responsive to whether vehicle ignition 118 is on or off. In step 616, independently retracting one or more panels 106 in a portion of interior roof 126 responsive to a level of daylight or nightlight detected. In step 618, retracting mirror 128 attached to retractable arm 130 mounted to front unit 132. For instance, front unit 132 (e.g., bracket that attaches to retractable arm 130) mounted to dashboard 134 or center console 136 of vehicle 102. Further, mirror 128 is retracted up and out of way of windshield 124 when vehicle 102 not in use.

In step 620, manually retracting mirror 128 into position by pulling down and locking into place. In step 622, automatically retracting mirror 128 automatically into position when vehicle 102 is in use and out of position when vehicle 102 is not in use.

It should be noted that step(s) 606-622 is/are an optional step and may not be implemented in all cases. Optional steps of method 600 are illustrated using dotted lines in FIG. 6 so as to distinguish them from the other steps of method 600.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

Upon reading this specification, it should be appreciated that, under appropriate circumstances, considering such issues as user preferences, design preference, structural requirements, marketing preferences, cost, available materials, technological advances, etc., other sun protection arrangements than those for automotive deployment such as, for example, sun protection for aircraft and water craft as well, etc., may be sufficient.

Those with ordinary skill in the art will now appreciate that upon reading this specification and by their understanding the art of Day & Night sun protection as described herein, methods of Day & Night sun protection will be understood by those knowledgeable in such art.

What is claimed is new and desired to be protected by Letters Patent is set forth in the appended claims:

1. (canceled)

2. The system of claim 21, wherein the darkened, translucent plastic material includes any or all the following or combinations thereof: tinted polycarbonate sheets, tinted plexiglass arylic sheets, grey tinted Lexan™ sheets, tinted polarized plastic sheets, smoked clear plastic sheets, vinyl charcoal tint, transitions photochromic sheets, and plastic polymer sheets.

3. The system of claim 21, comprising a wireless connection unit coupled to a vehicle ignition system, the wireless connection unit configured to automatically retract the panels upon detection of the vehicle ignition system in an off-position.

4. (canceled)

5. The system of claim 21, wherein said wireless connection unit is configured to be responsive to said interior temperature level in a first threshold setting, such that it will raise said panels to lower said interior temperature level of said vehicle; and be responsive to said interior temperature level in a second threshold setting, such that it will lower said side windows to lower said interior temperature level in said vehicle.

6. The system of claim 21, wherein said series of panels are adapted to be installed in said interior of said vehicle at the rear window and the front interior windshield, such that said series of panels are independently and incrementally retractable from each other.

7. The system of claim 21, wherein one of said series of panels are adapted to be retractably installed in a portion of an interior roof; wherein said series of panels are independently and incrementally retractable from each other; and wherein one of said series of panels over a rear window partially or fully retracts to increase visibility to a driver of said vehicle during night time.

8. (canceled)

9. The system of claim 22, wherein said mirror is adapted to be retracted manually into position by pulling down and locking said mirror into place.

10. The system of claim 22, wherein said mirror is adapted to be automatically retracted into position when said vehicle is in use and out of position when said vehicle is not in use.

11. (canceled)

12. The method of claim 23, wherein incrementally retracting the darkened, translucent plastic material panels includes incrementally retracting panels including materials any or all the following or combinations thereof: tinted polycarbonate sheets, tinted plexiglass arylic sheets, grey tinted Lexan™ sheets, tinted polarized plastic sheets, smoked clear plastic sheets, vinyl charcoal tint, transitions photochromic sheets, and plastic polymer sheets.

13. The method of claim 23, comprising retracting automatically the panels upon detection of the vehicle ignition system in an off-position.

14. (canceled)

15. The method of claim 23, wherein said wireless connection unit is configured to be responsive to said interior temperature level in a first threshold setting, such that it will raise said panels to lower said interior temperature level of the vehicle; and be responsive to said interior temperature level in a second threshold setting, such that it will lower said side windows to lower said interior temperature level of said vehicle.

16. The method of claim 23, further comprising the step of independently retracting said one or more panels in said interior of said vehicle at the rear window, and the front interior windshield responsive to whether said vehicle ignition is on or off.

17. The method of claim 23, further comprising the step of independently retracting one or more panels in a portion of an interior roof portion of said vehicle responsive to an amount of daylight or nightlight detected.

18. The method of claim 23, further comprising the step of retracting a mirror attached to a retractable arm mounted to a front unit; wherein said front unit is mounted to a dashboard or center console of said vehicle; and wherein said mirror is retracted up and out of the way of a windshield of said vehicle when said vehicle is not in use.

19. The method of claim 18, further comprising the step of manually retracting said mirror into position by pulling down and locking it into place.

20. The method of claim 18, further comprising the step of automatically retracting said mirror into position when said vehicle is in use and out of position when said vehicle is not in use.

21. A sun protection system for a vehicle that assists maintaining an interior temperature level of said vehicle comprising:
a series of rigid retractable, darkened, translucent plastic material panels;
wherein said panels are adapted to be retractably installed inside
door panels of side windows of said vehicle;
wherein said panels are adapted to be incrementally retractable independent of said side windows and configured to cover or expose one or more portions of said side windows responsive to at least one of a detected interior temperature level, an amount of sunlight entering said vehicle, and a predicted interior temperature level of said vehicle; and
a wireless connection unit;
wherein said wireless connection unit is adapted to be coupled to an ignition system of said vehicle; and
wherein said wireless connection unit is configured to automatically retract said panels when headlights in said vehicle are turned on.

22. A sun protection system for a vehicle that assists maintaining an interior temperature level of said vehicle comprising:
a series of rigid retractable, darkened, translucent plastic material panels;
wherein said panels are adapted to be retractably installed inside door panels of side windows of said vehicle;
wherein said panels are adapted to be incrementally retractable independent of said side windows and configured to cover or expose one or more portions of said side windows responsive to at least one of a detected interior temperature level, an amount of sunlight entering said vehicle, and a predicted interior temperature level of said vehicle; and
a mirror;
wherein said mirror is attached to a retractable arm mounted to a front unit; and wherein said front unit is adapted to be mounted to a dashboard or center console of said vehicle, such that said mirror can be retracted upward and out of the way of a windshield of said vehicle when said vehicle is not in use.

23. A method for a vehicle to provide sun protection for individuals, objects, and pets inside said vehicle and to assist maintaining an interior temperature level within a specified range, said method comprising the steps of:
incrementally retracting a series of one or more rigid darkened, translucent plastic material panels installed inside door panels of side windows of said vehicle;
retracting independently panels of said side windows that are manually or automatically configured to cover or expose one or more portions of said side windows responsive to at least one of a detected interior temperature level and an amount of sunlight entering said vehicle, and to maintain said interior temperature level responsive to a predicted interior temperature level of said vehicle; and
retracting automatically said panels when lights in said vehicle are turned on via a wireless connection unit coupled to a vehicle ignition system of said vehicle.
